(19) United States
(12) Patent Application Publication
(10) Pub. No.: US 2010/0284355 A1
(43) Pub. Date: Nov. 11, 2010

(54) HANDSHAKING METHOD, AND TRANSMISSION POWER DETERMINING METHOD AND APPARATUS THEREOF FOR PARALLEL TRANSMISSION OF MULTIPLE STREAMS IN SINGLE RADIO CHANNEL

(75) Inventors: Kiung Jung, Seoul (KR); Sung-Jin You, Daejeon-City (KR); Gwangzeen Ko, Seoul (KR); Myung-Sun Song, Daejeon-City (KR); Chang-Joo Kim, Daejeon-City (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/746,253

(22) PCT Filed: Dec. 10, 2008
(86) PCT No.: PCT/KR2008/007296

§ 371 Date: Jun. 4, 2010

Related U.S. Application Data
(60) Provisional application No. 61/012,516, filed on Dec. 10, 2007.

(30) Foreign Application Priority Data
Dec. 9, 2008 (KR) 10-2008-0124657

(51) Int. Cl. H04W 52/24

(52) U.S. Cl. 370/329

(57) ABSTRACT

Provided are a transmission power determining method and an apparatus thereof for parallel transmission of a plurality of streams. In a wireless communication system, the transmission power determining method and apparatus determine a transmission power suitable for allowing the plurality of streams to be simultaneously and reliably transmitted in a mutually permissible interference range, and use a Hidden Handshaking (HHS) procedure to determine the transmission power. By doing so, it is possible to perform reliable channel allocation and to reliably transmit the plurality of streams.

### TECHNICAL FIELD

The present invention relates to a method of transmitting a plurality of streams in a radio network, and more particularly, to a handshaking method, and a transmission power determining method and apparatus thereof for parallel transmission of a plurality of streams in a single radio channel.

The present invention is supported by the Information Technology (IT) Research & Development (R&D) program of the Ministry of Information and Communication (MIC) [Project No. : 2005-S-002-03, Research title : Development of Cognitive Radio Technology for Efficient Spectrum Utilization.].

### BACKGROUND ART

Modern mobile communication systems use various kinds of multiple transmission technologies including Time Division Multiple Access (TDMA), Frequency Division Multiple Access (FDMA), Code Division Multiple Access (CDMA), etc. Such multiple transmission technologies allocate each stream to respective channels which are orthogonally separated from each other to avoid interference therebetween. However, these multiple transmission technologies do not consider allocating a plurality of streams to a single channel.

In the case of a wireless communication system such as an Ad hoc network or a wireless personal area network (e.g., Bluetooth, IEEE802.15.3, etc), traffic data between nodes is exchanged by direct communication between the nodes, instead of using a centralized method (e.g., a cellular system communicating via a base station). In this case, there is a high chance of the existence of streams that are spatially remote from each other and thus are sufficient to be simultaneously transmitted without mutual interference.

### DISCLOSURE OF INVENTION

### Technical Problem

There is required to determine a transmission power suitable for allowing the plurality of streams to be simultaneously and reliably transmitted in a mutually permissible interference range.

### TECHNICAL SOLUTION

The present invention provides a handshake protocol of a Medium Access Control (MAC) layer that supports parallel allocation of a plurality of streams to a single radio channel, and determines a transmission power sufficient to allow each of the parallel allocated streams to be reliably transmitted in a mutually permissible interference range when the plurality of streams are sufficiently spatially remote from each other.

### ADVANTAGEOUS EFFECTS

According to the embodiments of the present invention, in a wireless communication system, the HHS procedure is used to determine the transmission power suitable to allow the plurality of streams to be reliably and simultaneously transmitted in a mutually permissible interference range so that it is possible to perform reliable CCI-P parallel channel allocation and to transmit the plurality of streams.

The embodiments according to the present invention may achieve more efficient effects when they are applied to a network such as a wireless personal area network (WPAN) in which the plurality of nodes are distributed in clusters so that the plurality of streams of the nodes may be remote from each other, and thus, sufficiently free from mutual interference.

The embodiments according to the present invention support the parallel transmission with respect to the plurality of streams in the single radio channel by using the HSS procedure so that it is possible to increase system capacity and to reduce a system delay due to data transmission.

### DESCRIPTION OF DRAWINGS

The above and other features and advantages of the present invention will become more apparent by describing in detail exemplary embodiments thereof with reference to the attached drawings in which:

FIG. 1 is a flowchart of a method of parallel simultaneously transmitting a plurality of streams in a single channel, wherein the method is performed by a master node in a network, according to an embodiment of the present invention;

FIG. 2 is a flowchart of a method of sharing a channel with other nodes and simultaneously parallel transmitting a plurality of streams, performed by nodes in a network, according to another embodiment of the present invention;

FIG. 3 is a flowchart of a handshaking procedure according to another embodiment of the present invention;

FIG. 4 is a diagram of a pre-allocating and reporting procedure in two stream models with respect to parallel allocation via a Hidden Handshaking (HHS) procedure according to another embodiment of the present invention;

FIG. 5 is a diagram of a HHS procedure in the two stream models with respect to the parallel allocation using the HHS procedure, according to the embodiment of FIG. 4;

FIG. 6 is a flowchart of messages in the two stream models of FIGS. 4 and 5, via the HHS procedure;

FIG. 7 is a block diagram of a transmission power determining apparatus of a node for parallel transmission of a plurality of streams, according to an embodiment of the present invention; and

FIG. 8 is a diagram of an internal structure of a master node apparatus for parallel transmission of a plurality of streams, according to another embodiment of the present invention.

### BEST MODE

According to an aspect of the present invention, there is provided a transmission power determining method for parallel transmission of a plurality of streams in a single channel, the transmission power determining method including the operations of transmitting a power control frame to one or more receiving nodes; and determining a stream transmission power sufficient to allow the plurality of streams to be transmitted to the one or more receiving nodes without undergoing mutual interference between the plurality of streams, based on signal strength measurement results of the power control frame received from the one or more receiving nodes.

According to another aspect of the present invention, there is provided a handshaking method performed by a transmitting node to handshake with one or more receiving nodes, the handshaking method including the operations of transmitting a power control frame to the one or more receiving nodes; receiving response frames comprising signal strength measurement results of the power control frame from the one or more receiving nodes; and adjusting a transmission power of the power control frame according to the signal strength measurement results, and re-transmitting the power control frame, so as to determine a stream transmission power sufficient to allow a plurality of streams to be transmitted with undergoing permissible mutual interference between the plurality of streams.

According to another aspect of the present invention, there is provided a method of parallel transmitting a plurality of streams in a single channel, the method including the operations of pre-allocating the plurality of streams to the single channel by using a centralized controller, and broadcasting channel pre-allocation information to a network; receiving results of Hidden Handshaking (HHS) procedures from transmitting nodes of the plurality of streams, wherein the HHS procedures are performed between the transmitting nodes and receiving nodes of the plurality of streams according to the channel pre-allocation information; and confirming the pre-allocating according to whether a stream transmission power of each of the transmitting nodes satisfies a stream transmission power condition aimed to allow the plurality of streams to be transmitted to the receiving nodes with undergoing permissible mutual interference between the plurality of streams, wherein the stream transmission power is determined according to the results of the HHS procedures.

According to another aspect of the present invention, there is provided a transmission power determining apparatus for parallel transmission of a plurality of streams in a single channel, the transmission power determining apparatus including a frame transmitting and receiving unit transmitting a power control frame to one or more receiving nodes, and receiving signal strength measurement results of the power control frame from the one or more receiving nodes; and a transmission power determining unit determining a stream transmission power sufficient to allow the plurality of streams to be transmitted to the one or more receiving nodes with undergoing permissible mutual interference between the plurality of streams, based on the signal strength measurement results.

According to another aspect of the present invention, there is provided a computer readable recording medium having recorded thereon a program for executing a transmission power determining method for parallel transmission of a plurality of streams in a single channel, a handshaking method performed by a transmitting node to handshake with one or more receiving nodes, and a method of parallel transmitting a plurality of streams in a single channel.

### MODE FOR INVENTION

The present invention will now be described more fully with reference to the accompanying drawings, in which exemplary embodiments of the invention are shown. Like reference numerals in the drawings denote like elements. In the following description, well-known functions or constructions are not described in detail since they would obscure the invention with unnecessary detail.

Also, when a part ‘includes’ or ‘comprises’ an element, unless there is a particular description contrary thereto, the part can further include other elements, not excluding the other elements. The term ‘unit’ in one or more embodiments of the present invention means a unit that performs at least a function or an operation, and this ‘unit’ may be embodied as hardware, software or a combination of hardware and software.

The one or more embodiments of the present invention includes a protocol of a Medium Access Control (MAC) layer that supports parallel allocation of a plurality of streams to a single radio channel, and that determines a transmission power sufficient to allow each of the parallel allocated streams to be reliably transmitted in a mutually permissible interference range. In the one or more embodiments of the present invention, handshake based power control for determining a transmission power of a plurality of streams is referred to as a Hidden Handshaking (HHS) procedure. The HHS procedure according to the one or more embodiments of the present invention may be applied to all communication systems including a centralized system, a distributed system, and the like, regardless of the types of systems.

In the one or more embodiments of the present invention, parallel channel allocation (also referred to as parallel stream allocation) indicates a channel allocation method that simultaneously allocates a plurality of streams to a single transmission channel so as to simultaneously transmit the plurality of streams. A transmission channel used by the channel allocation method varies according to transmission technologies. For example, a time slot period in the case of Time Division Multiple Access (TDMA), a frequency band in the case of Frequency Division Multiple Access (FDMA), and an orthogonal code in the case of Code Division Multiple Access (CDMA), may be the single transmission channel to which the plurality of streams are allocated.

In order to achieve parallel allocation of the plurality of streams via the parallel channel allocation, it is necessary to determine a mutually permissible interference amount, and a reliable transmission power. According to the related art, in order to determine a transmission power in consideration of reducing power consumption, closed-loop power control has been widely used in wireless communication systems. However, handshake based control, which is for simultaneously controlling the transmission power and a mutual interference caused by the transmission power and the effect of other transmissions, is unknown. Thus, with respect to parallel allocated streams, a procedure of the MAC layer for determining the reliable transmission power in a mutually permissible interference range, that is, the HSS procedure is required.

Hereinafter, the one or more embodiments of the present invention will be described by referring to a network system including a master station (MS) and a member station (MB) but the one or more embodiments of the present invention are not limited to this network system. The MS indicates a device that functions as a base station controlling an entire network or functions as a network coordinator, and the MB indicates each node device that is controlled by the MS in the network.

The MS broadcasts a control frame including network information during a control channel period in a super frame, or controls MBs according to a command frame exchange between the MS and an MB, or between the MBs during a command channel period in the super frame, wherein the MBs are randomly distributed in its network. Traffic data is directly communicated between the MBs during a traffic channel period, thereby bypassing the MS.

Hereinafter, for convenience of description, the one or more embodiments of the present invention will be described by referring to the case of two streams. However, it will be understood by one of ordinary skill in the art that the one or more embodiments of the present invention may be applied to the case of three or more streams.

A method of parallel transmitting a plurality of streams in a single channel includes the following operations.

Step 1 (pre-allocation): An MS pre-allocates a plurality of streams to a single radio channel according to a Co-channel Interference Permissible (CCI-P) parallel channel allocation algorithm. The parallel channel allocation of the CCI-P parallel channel allocation algorithm is determined as a channel allocation method (hereinafter, referred to as a ‘CCI-P parallel channel allocation’) that allocates each of a plurality of streams to the single radio channel according to the degree of CCI, and thus allows the plurality of streams to be free from mutual interference.

Step 2 (pre-allocation informing operation) : The MS broadcasts channel pre-allocation information to all MBs in a network during a control channel period in a super frame,

Step 3 (HHS procedure) : The pre-allocation performed in step 1 is confirmed and adjusted.

Step 4 (confirmation of allocation) : Allocation according to a result of step 3 is finally confirmed.

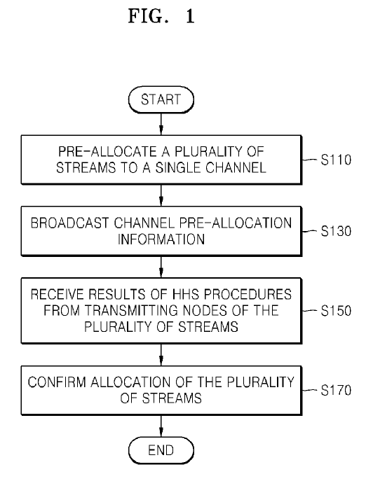

FIG. 1 is a flowchart of a method of parallel simultaneously transmitting a plurality of streams in a single channel, wherein the method is performed by a master node in a network, according to an embodiment of the present invention.

The master node functioning as a centralized controller pre-allocates a plurality of parallel transmissible streams to the single channel (operation S110). This channel pre-allocation may be performed according to the CCI-P parallel channel allocation so that the plurality of streams are free from mutual interference.

The master node broadcasts channel pre-allocation information to the network (operation S130). The channel pre-allocation information may include information about the parallel allocation of the plurality of streams to the single channel by the master node, and an initial transmission power of each of the plurality of streams, communication parameter threshold values (e.g., a signal strength threshold value required at a receiving node of a corresponding stream, an interference amount threshold value required at a receiving node of another stream simultaneously transmitted along with the corresponding stream, and the like).

The master node receives a result of a handshaking procedure between a transmitting node and a receiving node from each transmitting node of the plurality of streams (operation S 150). According to the channel pre-allocation information received from the master node, each transmitting node of the plurality of streams performs a handshaking procedure by using a handshake protocol with each receiving node of the plurality of streams so as to determine a stream transmission power and to control interference, and then transmits a result of the handshaking procedure to the master node.

The master node checks the result of the handshaking procedure received from each transmitting node of the plurality of streams, and confirms the parallel allocation of the plurality of streams via the pre-allocation (operation S 170). The master node confirms the pre-allocation according to whether the stream transmission power, which is determined according to the result of the handshaking procedure, satisfies a stream transmission power condition aimed at allowing the plurality of streams to be transmitted to each receiving node with undergoing permissible mutual interference between the plurality of streams.

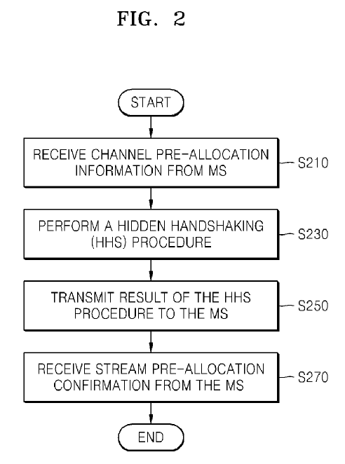

FIG. 2 is a flowchart of a method of sharing a channel with other nodes and simultaneously parallel transmitting a plurality of streams, performed by nodes in a network, according to another embodiment of the present invention.

Referring to FIG. 2, a transmitting node, which has a corresponding stream to transmit, receives channel pre-allocation information broadcast from a master node (operation S210).

Based on the received channel pre-allocation information, the transmitting node performs a handshaking procedure with a receiving node to receive the corresponding stream, and with other receiving nodes to receive parallel streams to be parallel transmitted along with the corresponding stream (operation S230). The handshaking procedure in the current embodiment indicates a procedure at a MAC layer for control and verification of interference and a transmissions power before the plurality of streams are actually transmitted. As described above, this handshaking procedure is referred to as the HHS procedure. The transmitting node that has undergone the HHS procedure may determine a stream transmission power sufficient to allow the plurality of streams to be transmitted to the receiving nodes with undergoing permissible mutual interference between the plurality of streams.

The transmitting node ends the HSS procedure, and transmits a result of the HSS procedure to the master node (operation S250).

Based on the result of the HSS procedure transmitted from each transmitting node, the transmitting node is confirmed by the master node with respect to stream pre-allocation (operation S270).

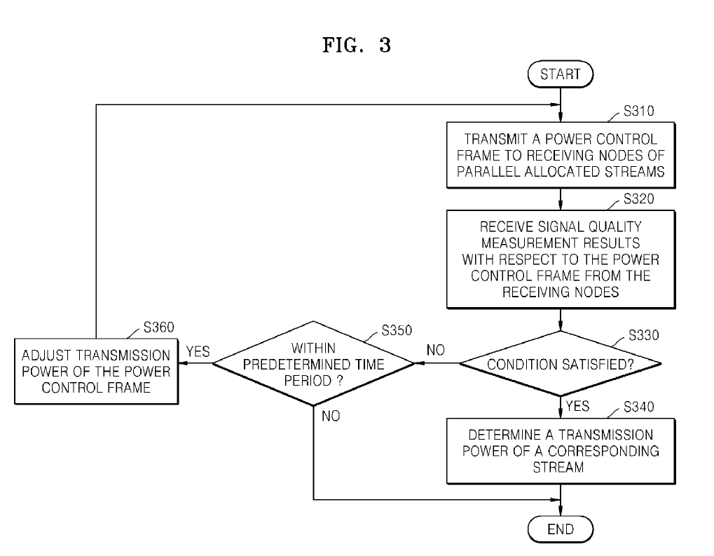

FIG. 3 is a flowchart of a handshaking procedure and a stream transmission power determining method using the handshaking procedure according to another embodiment of the present invention.

Referring to FIG. 3, a transmitting node of a corresponding stream transmits a power control frame for measurement of a signal strength and an interference amount to a receiving node of the corresponding stream and to each receiving node of parallel streams (operation S310).

The transmitting node receives signal strength measurement results with respect to the power control frame from the receiving nodes (operation S320). The signal strength measurement results include a signal strength or a result of comparison between a signal strength threshold value and the signal strength which is measured when the receiving node of the corresponding stream receives the power control frame, and an interference amount or a result of comparison between an interference amount threshold value and the interference amount which is measured when each receiving node of the parallel streams receives the power control frame.

After receiving response frames including such measurement results from the receiving node of the corresponding stream and each receiving node of the parallel streams, the transmitting node determines whether the measurement results satisfy a reference condition (operation S330).

If satisfied, the transmitting node determines a transmission power of the corresponding stream based on a transmission power of the power control frame for the case where the reference condition is satisfied (operation S340).

However, if not satisfied, the transmitting node determines whether a predetermined time period is elapsed (operation S350).

If the predetermined time period has not elapsed, the transmitting node adjusts the transmission power of the power control frame (operation S360), and then re-performs operation 310 and the operations thereafter. If the predetermined time period has elapsed, the transmitting node ends a HHS procedure. The predetermined time period may vary according to a system environment.

The reference condition for determining the transmission power of the corresponding stream in the HHS procedure may vary according to a system status or a selection of an administrator, and thus is not limited to the following case.

In the following case, a transmitting node determines the reference condition when a signal strength at a receiving node of a corresponding stream is greater than a signal strength threshold value, and an interference amount at a receiving node of a parallel stream is lower than an interference amount threshold value. The Interference amount at the receiving node of a parallel stream may be determined based on a signal strength of the received signal.

After an MS broadcasts a REQ_{ITC/CCI} command frame to all MBs, and thus requests measurement of signal strengths and interference amounts at receiving terminals of a plurality of streams, a transmitting terminal of a stream 2 from among the streams may determine a transmitting power based on a signal-to-noise ratio (SNR) at a receiving terminal of the stream 2, and an interference amount at a receiving terminal of a stream 1 from among the streams according to the following 4 conditions.

Condition 1 (No signal and no interference) : This is where a signal strength at the receiving terminal of the stream 2 is lower than Γ_{SNR}, that is, a required threshold value of the SNR, and an interference amount at the receiving terminal of the stream 1 is lower than Γᵢₙₜ, that is, a permissible threshold value of the interference amount.

Condition 2 (No signal but interference) : This is where the signal strength at the receiving terminal of the stream 2 is lower than Γ_{SNR}, and the interference amount at the receiving terminal of the stream 1 is greater than Γᵢₙₜ.

Condition 3 (No interference but signal) : This is where the signal strength at the receiving terminal of the stream 2 is greater than Γ_{SNR}, and the interference amount at the receiving terminal of the stream 1 is lower Γᵢₙₜ.

Condition 4 (With signal and interference): This is where the signal strength at the receiving terminal of the stream 2 is greater than Γ_{SNR}, and the interference amount at the receiving terminal of the stream 1 is greater than Γᵢₙₜ.

According to the conditions based on responses from the receiving terminals of the streams 1 and 2, a transmission power is adjusted and determined in a step-by-step manner. For example, when condition 3 is satisfied, a transmission power at condition 3 is determined as a transmission power used in a CCI-P parallel transmission.

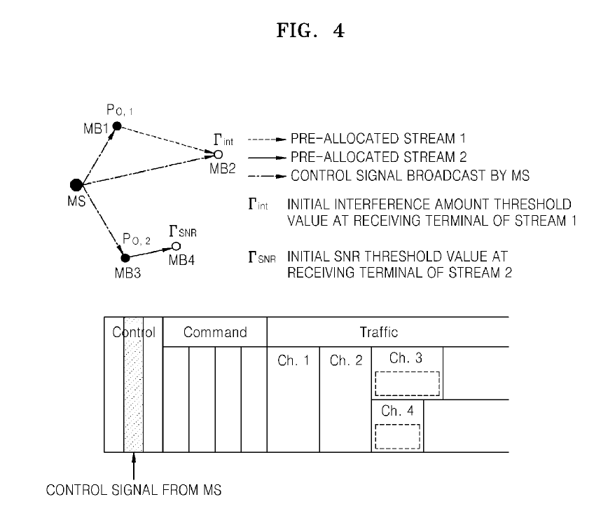

FIG. 4 is diagram of a pre-allocating and reporting procedure in two stream models with respect to parallel allocation using a HHS procedure according to another embodiment of the present invention. The case of FIG. 4 is related to a TDMA transmission technology but it will be understood by one of ordinary skill in the art that the case of FIG. 4 may be applied to other wireless communication technologies.

Channel pre-allocation is performed on each of the two streams according to a CCI-P parallel channel allocation algorithm. From among the two streams that request an MS for channel allocation, a stream 1 is transmitted from an MB 1 to an MB 2, and a stream 2 is transmitted from an MB 3 to an MB 4.

A control channel is a period during which the MS broadcasts a control frame to all MBs in a network, a command channel is a period during which the MS and one of the MBs, or the MBs exchange a command frame, and a traffic channel is a period during which traffic data is transmitted between the MBs. These channels are horizontally orthogonal to each other but not vertically orthogonal.

Referring to FIG. 4, the stream 1 and the stream 2 are respectively pre-allocated to a frequency band, a channel 3, a channel 4, and a same timeslot period of the traffic channel. At this time, the MS determines Pₒ₁, that is, an initial transmission power of the stream 1; Pₒ₂, that is, an initial transmission power of the stream 2;Γᵢₙₜ that is, a permissible interference amount threshold value at a receiving terminal (MB 2) of the stream 1; and Γ_{SNR}, that is, a required SNR threshold value at a receiving terminal (MB 4) of the stream 2.

The MS broadcasts a control signal at a start point of a super frame, and at this time, channel pre-allocation information is broadcast from the MS to all MBs in a network via the control channel. The MBs that have streams to transmit prepare to perform the HHS procedure.

A confirmation and adjustment procedure is performed in the command channel.

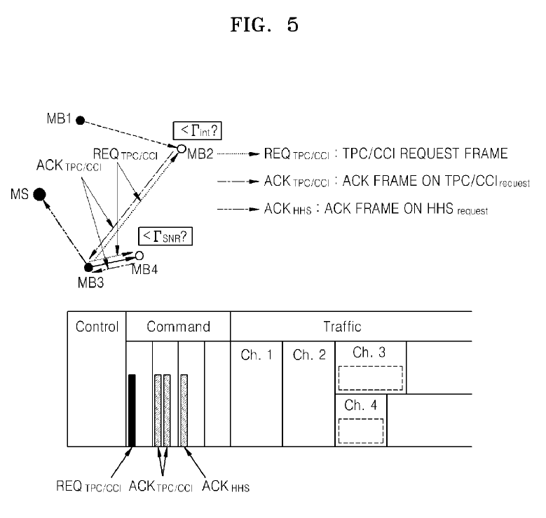

FIG. 5 is a diagram of a HHS procedure in the two stream models with respect to the parallel allocation using the HHS procedure, according to the embodiment of FIG. 4.

First, a receiving terminal MB 3 of the stream 2 transmits a REQ_{TCP/CCI} command frame to a receiving terminal MB 4 of the stream 2 by using the initial transmission power Pₒ₂, and requests a check of whether a signal strength is sufficiently great. At the same time, the REQ_{TCP/CCI} command frame is broadcast to the receiving terminal MB 2 of the stream 1. When the receiving terminal MB 4 receives the REQ_{TCP/CCI} command frame from the receiving terminal MB 3, the receiving terminal MB 4 checks whether the signal strength is greater than Γ_{SNR}, that is, the required SNR threshold value, and thus transmits an ACK_{TPC/CCI} command frame including a result of the check to the receiving terminal MB 3. At the same time, when the receiving terminal MB 2 receives the REQ_{TCP/CCI} command frame from the receiving terminal MB 3, the receiving terminal MB 2 checks whether the signal strength is lower than Γᵢₙₜ that is, the permissible threshold value, and thus transmits an ACK_{TCP/CCI} command frame including a result of the check to the receiving terminal MB 3.

In the case where the receiving terminal MB 3 does not receive a satisfied condition (that is, condition 3 : No interference but signal) with respect to a permissible interference amount for the stream 1 and a required signal strength for the stream 2 from the receiving terminal MB 2 or the receiving terminal MB 4, respectively, the receiving terminal MB 3 adjusts a transmitting power of the REQ_{TCP/CCI} command frame in a step-by-step manner, and then re-performs the aforementioned operations. During a predetermined time period, such an HHS procedure is repeatedly performed to satisfy condition 3 with respect to the two receiving terminals MB 4 and MB 2.

When the HHS procedure with respect to the stream 2 is ended, a same procedure is performed with respect to the stream 1. When the HHS procedures with respect to the streams 1 and 2 are ended, the receiving terminals MB 1 and MB 3 respectively transmit a result thereof to the MS via an ACK_{HHS} command frame during the command channel period.

If the receiving terminals MB 1 and MB 3 satisfy condition 3, the MS confirms the parallel allocation, and informs all MBs in the network via a Confirm_{HHS} command frame during the command channel period. If the MS determines that the parallel allocation has failed, the MS selects whether to attempt another allocation and thus to repeat the HHS procedure during the command channel period of the current super frame, or whether to select one of the streams 1 and 2 and thus to allocate only the selected stream to the current super frame. After selection, the MS informs a result of the selection to all MBs in the network.

The receiving terminals MB 1 and MB 3 having received an acknowledgment message from the MS transmit the streams 1 and 2 during the pre-allocated frequency channel period and timeslot.

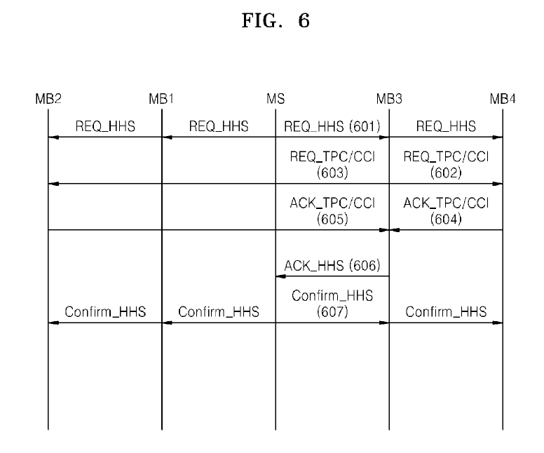

FIG. 6 is a flowchart of messages in the two stream models of FIGS. 4 and 5, via the HHS procedure.

An MS broadcasts an HHS request command frame REQ_HHS 601 to nodes MB 1, MB 2, MB 3, and MB 4 in a network so as to request the nodes MB 1, MB 2, MB 3, and MB 4 to perform the HHS procedure. The MS may not separately transmit a command frame but may broadcast channel pre-allocation information, which is information about streams parallel allocated to a single channel according to a CCI-P parallel channel allocation algorithm, to the nodes MB 1, MB 2, MB 3, and MB 4, thereby allowing the nodes MB 1, MB 2, MB 3, and MB 4 to perform the HHS procedure.

The streams, which are a stream 1 and a stream 2 and which are allocated to the single channel, are respectively transmitted to a receiving node MB 2 and a receiving node MB 4 by a transmitting node MB 1 and a transmitting node MB 3. [77] In order to simultaneously control a transmission power and a channel interference amount at the receiving node MB 2 of the stream 1, the transmitting node MB 3 of the stream 2 transmits signal strength and interference amount measurement requesting command frames REQ_TPC/CCI 602 and 603 respectively to the receiving node MB 4 and the receiving node MB 2 by using a transmission power initially allocated by the MS.

The receiving node MB 4 of the stream 2 compares a signal strength of the command frame REQ_TPC/CCI 602 with a signal strength threshold value, and thus transmits a result of the comparison to the transmitting node MB 3 via an ACK_TPC/CCI 604. The receiving node MB 2 of the stream 1 compares a signal strength of the command frame REQ_TPC/CCI 603 with an interference amount threshold value, and thus transmits a result of the comparison to the transmitting node MB 3 via an ACK_TPC/CCI 605.

The transmitting node MB 3 determines whether the signal strength is greater than the signal strength threshold value at the receiving node MB 4, and whether the signal strength is lower than the interference amount threshold value at the receiving node MB 2, and thus adjusts a transmission power of the command frame REQ_TPC/CCI and repeatedly transmits the command frame REQ_TPC/CCI during a predetermined time period until a result of the determination satisfies a reference condition.

When the reference condition is satisfied, the transmitting node MB 3 determines a transmission power of the stream 2 based on the transmission power of the command frame REQ_TPC/CCI, and thus reports a result of the HHS procedure to the MS via an ACK_HHS 606.

The HHS procedure is equally performed with respect to the stream 1, and a result thereof is transmitted from the transmitting node MB 1 to the MS.

When the HHS procedure results from the transmitting nodes MB 1 and MB 3 all satisfy the reference condition, the MS confirms pre-allocation via a Confirm_HHS 607. When the HHS procedure results do not satisfy the reference condition, the MS re-allocates other streams to the single channel, or allocates only one of the streams 1 and 2 to the single channel, and broadcasts a result of the allocation to nodes in the network.

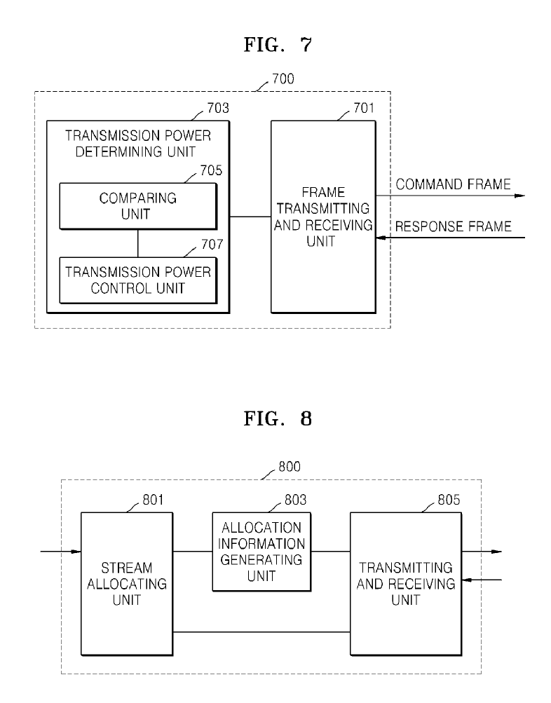

FIG. 7 is a block diagram of a transmission power determining apparatus 700 of a node for parallel transmission of a plurality of streams, according to an embodiment of the present invention. A detailed description about the aforementioned overlapping description will be omitted here.

Referring to FIG. 7, the transmission power determining apparatus 700 includes a frame transmitting and receiving unit 701 and a transmission power determining unit 703. The transmission power determining unit 703 includes a comparing unit 705 and a transmission power control unit 707.

The frame transmitting and receiving unit 701 transmits a command frame, that is, a power control frame to all receiving nodes of the plurality of streams, and receives response frames including signal strength measurement results measured upon the receipt of the power control frame from the receiving nodes.

According to the signal strength measurement results, the transmission power determining unit 703 determines a stream transmission power sufficient to allow the plurality of streams to be reliably transmitted to the receiving nodes, with undergoing permissible mutual interference between the plurality of streams. The transmission power determining unit 703 determines a transmission power of a corresponding stream based on a signal strength of the power control frame measured by a receiving node of the corresponding stream, and an interference amount of the power control frame measured by each of receiving nodes of other streams being parallel transmitted along with the corresponding stream.

The comparing unit 705 determines whether the signal strength and the interference amount satisfy a reference condition. For example, the comparing unit 705 may determine whether the signal strength of the power control frame is greater than a first threshold value (that is, a signal strength threshold value) and whether the interference amount of the power control frame is lower than a second threshold value (that is, an interference value threshold value), thereby determining whether the reference condition is satisfied. The transmission power control unit 707 controls the transmission power to be adjusted, and controls the power control frame to be re-transmitted during a predetermined time period until the signal strength and the interference amount satisfy the reference condition.

FIG. 8 is a diagram of an internal structure of a master node apparatus 800 for parallel transmission of a plurality of streams, according to another embodiment of the present invention. A detailed description about the aforementioned overlapping description will be omitted here.

Referring to FIG. 8, the master node apparatus 800 includes a stream allocating unit 801, an allocation information generating unit 803, and a transmitting and receiving unit 805.

The stream allocating unit 801 pre-allocates a plurality of parallel transmissible streams to a single channel by using a predetermined channel allocation algorithm. Channel pre-allocation information may include an initial transmission power of each stream, a SNR threshold value, and an interference amount threshold value. The stream allocating unit 801 may receive results of a HHS procedure performed by each transmitting node of the plurality of streams with each receiving node of the plurality of streams in order to determine a stream transmission power and to control an interference according to the channel pre-allocation information, and thus may adjust parallel allocation of the plurality of streams. According to the results of the HHS procedure, the stream allocating unit 801 may adjust whether to keep maintaining the pre-allocation of the plurality of streams, whether to re-allocate a plurality of streams, or whether to allocate only a single stream.

The allocation information generating unit 803 broadcasts the channel pre-allocation information and a result of adjusting the parallel allocation of the plurality of streams, which are stored in a storage device such as a memory, to a network.

The transmitting and receiving unit 805 transmits information to nodes in each network, and receives various kinds of information as well as information about the results of the HHS procedure from the nodes.

The node or the station of the embodiments according to the present invention may include a known calculating system that may be suitable for the embodiments, and environment and/or configurations of the embodiments according to the present invention may include PCs, server computers, hand-held products or lap-top devices, multi-processor systems, microprocessor-based systems, programmable consumer electronic devices, network PCs, mini-computers, mainframe computers, and the like but are not limited thereto.

In one or more other embodiments according to the present invention, a processor or a controller, which is programmed according to a computer software command to implement the one or more other embodiments, may not be used but hardware programmed by or associated with the computer software may be used. Thus, the present invention should not be construed as being limited to a specific association between hardware and software.

This application claims the benefit of U.S. Provisional Patent Application No, 61/012,516, filed on Dec. 10, 2007, in the U.S. Patent and Trademark Office, and the benefit of Korean Patent Application No. 10-2008-124657, filed on Dec. 9, 2008, in the Korean Intellectual Property Office, the disclosures of which are incorporated herein their entirety by reference.

The embodiments of the present invention can be written as computer programs and can be implemented in general-use digital computers that execute the programs using a computer readable recording medium. In addition, a data structure used in the embodiments of the present invention can be written in a computer readable recording medium through various means. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer-readable recording medium can also be distributed over network-coupled computer systems so that the computer-readable code is stored and executed in a distributed fashion.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. A transmission power determining method for parallel transmission of a plurality of streams in a single channel, the transmission power determining method comprising:
transmitting a power control frame to one or more receiving nodes; and
determining a stream transmission power sufficient to allow the plurality of streams to be transmitted to the one or more receiving nodes with undergoing permissible mutual interference between the plurality of streams, based on signal strength measurement results of the power control frame received from the one or more receiving nodes.

2. The transmission power determining method of claim 1, wherein the determining of the stream transmission power comprises determining the stream transmission power of a corresponding stream from among the plurality of streams according to a signal strength of the power control frame received and measured by a receiving node of the corresponding stream and according to an interference amount of the power control frame received and measured by receiving nodes of streams which are transmitted in parallel along the corresponding stream.

3. The transmission power determining method of claim 2, wherein the determining of the stream transmission power comprises:
determining whether the signal strength and the interference amount satisfy a reference condition; and
determining the stream transmission power of the corresponding stream based on a transmission power of the power control frame when the reference condition is satisfied.

4. A handshaking method performed by a transmitting node to handshake with one or more receiving nodes, the handshaking method comprising:
transmitting a power control frame to the one or more receiving nodes;
receiving response frames comprising signal strength measurement results of the power control frame from the one or more receiving nodes; and
adjusting a transmission power of the power control frame according to the signal strength measurement results, and re-transmitting the power control frame, so as to determine a stream transmission power sufficient to allow a plurality of streams to be transmitted to the one or more receiving nodes with undergoing permissible mutual interference between the plurality of streams.

5. The handshaking method of claim 4, wherein the receiving of the response frames comprises:
receiving the response frame comprising a measurement result about a signal strength of the power control frame from a receiving node of a corresponding stream from among the plurality of streams; and
receiving the response frame comprising a measurement result about an interference amount of the power control frame from receiving nodes of streams that are transmitted in parallel along with the corresponding stream.

6. The handshaking method of claim 4, wherein the re-transmitting comprises:
determining whether the signal strength and the interference amount satisfy a reference condition; and
adjusting a stream transmission power of the power control frame and re-transmitting the stream transmission power during a predetermined time period until the reference condition is satisfied.

7. A method of parallel transmitting a plurality of streams in a single channel, the method comprising:
pre-allocating the plurality of streams to the single channel by using a centralized controller, and broadcasting channel pre-allocation information to a network;
receiving results of HHS (Hidden Handshaking) procedures from transmitting nodes of the plurality of streams, wherein the HHS procedures are performed between the transmitting nodes and receiving nodes of the plurality of streams according to the channel pre-allocation information; and
confirming the pre-allocating according to whether a stream transmission power of each of the transmitting nodes satisfies a stream transmission power condition aimed to allow the plurality of streams to be transmitted to the receiving nodes with undergoing permissible mutual interference between the plurality of streams, wherein the stream transmission power is determined according to the results of the HHS procedures.

8. The method of claim 7, wherein the HHS procedures, performed by the transmitting nodes, comprises:
transmitting a power control frame to the receiving nodes;
receiving a measurement result about a signal strength of the power control frame from a corresponding receiving node from among the receiving nodes, and receiving measurement results about an interference amount of the power control frame from the rest of the receiving nodes;
adjusting a transmission power of the power control frame according to the signal strength and the interference amount, and re-transmitting the power control frame; and
determining a stream transmission power based on the transmission power of the power control frame.

9. A transmission power determining apparatus for parallel transmission of a plurality of streams in a single channel, the transmission power determining apparatus comprising:
a frame transmitting and receiving unit transmitting a power control frame to one or more receiving nodes, and receiving signal strength measurement results of the power control frame from the one or more receiving nodes; and
a transmission power determining unit determining a stream transmission power sufficient to allow the plurality of streams to be transmitted to the one or more receiving nodes with undergoing permissible mutual interference between the plurality of streams, based on the signal strength measurement results.

10. The transmission power determining apparatus of claim 9, wherein the transmission power determining unit determines the stream transmission power of a corresponding stream from among the plurality of streams based on a signal strength of the power control frame received and measured by a receiving node of the corresponding stream and based on an interference amount of the power control frame received and measured by receiving nodes of streams which are transmitted in parallel along the corresponding stream.

11. The transmission power determining apparatus of claim 10, wherein the transmission power determining unit further comprises:
a comparing unit determining whether the signal strength and the interference amount satisfy a reference condition; and
a transmission power control unit adjusting a transmission power of the power control frame and controlling re-transmission of the power control frame during a predetermined time period until the reference condition is satisfied.

12. The transmission power determining apparatus of claim 11, wherein the comparing unit determines whether the signal strength of the power control frame is greater than a first threshold value and whether the interference amount of the power control frame is lower than a second threshold value.
